(19) United States
(12) Patent Application Publication
(10) Pub. No.: US 2026/0133787 A1
(43) Pub. Date: May 14, 2026

(54) SCHEDULING AN UPDATE OF A CONNECTED COMPANION DEVICE BASED ON LIKELIHOOD OF USAGE

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 18/948,162

(22) Filed: Nov. 14, 2024

(51) Int. Cl. G06F 8/65; G06F 8/61

(52) U.S. Cl. CPC G06F 8/65; G06F 8/61

(57) ABSTRACT

An electronic device, a method, and a computer program product manage update a companion device to avoid inconveniencing a user of a connected device ecosystem. The electronic device communicates/manages, via a communications subsystem, an ecosystem of connected devices including a companion device and a second electronic device. A processor is configured to cause the electronic device to receive a software update for the companion device, determine a required update installation time, and determine a context of usage of the companion device, in part based on current and predicted usage of at least one of the electronic device and second electronic device. The context of usage indicates a likelihood of usage of the companion device during the installation time. The processor manages installation of the software update on the companion device responsive to the context of usage being less than a likelihood threshold.

### BACKGROUND

### 1. Technical Field

The present disclosure relates generally to electronic devices that can receive and install a software update, and more particularly to electronic devices that can receive and install a software update to a connected companion device.

### 2. Description of the Related Art

Electronic devices such as smartphones, desktop laptops, and tablets are increasingly being used by users in a connected device ecosystem. Connection between these devices enables particular functions of each device to support the other. In an example, a smartphone may have superior communication capabilities, and a desktop computer may have a larger display and a physical keyboard. A smart connection within the connected device ecosystem allows a user to work from one or more of the connected devices while having the benefit of the features provided by other connected devices. The connected device ecosystem may also include companion devices such as wearables, smart home devices, and Internet of Things (IoT) gadgets. Just like primary or secondary devices such as computers and smartphones, these companion devices may operate on sophisticated software platforms that require regular software updates to enhance functionality, security, and user experience.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a communication device in which the features of the present disclosure are advantageously implemented for updating a companion device in a connected device ecosystem without inconveniencing a user, according to one or more embodiments;

FIG. 2 is a simplified block diagram of the communication device having additional communication interfaces for wireless communications within the connected device ecosystem and with other devices, according to one or more embodiments;

FIG. 3 is a top view of an example connected device ecosystem that includes headphones as a companion device that is not in use in a first situation and in use in a second situation, according to one or more embodiments;

FIG. 4 is a front view of another example connected device ecosystem that includes a smartwatch as a companion device that is not in use in a first situation and in use in a second situation, according to one or more embodiments;

FIG. 5 is a processing diagram of a deterministic companion device update management (CDUM) module interacting with a central hub provided by the communication device, according to one or more embodiments;

FIG. 6 is a processing diagram of a predictive CDUM module utilizing collected data on context and user behavior, according to one or more embodiments;

FIG. 7 is a flow diagram presenting a method for deterministically managing a companion device update, according to one or more embodiments; and

FIG. 8 is a flow diagram presenting a method for predictively managing a companion device update, according to one or more embodiments; and

FIGS. 9A-9B (collectively “FIG. 9”) are a flow diagram presenting a method for updating a companion device in a connected device ecosystem without inconveniencing a user, according to one or more embodiments.

### DETAILED DESCRIPTION

According to aspects of the present disclosure, an electronic device, a method and a computer program provides techniques for updating a companion device in a connected device ecosystem without inconveniencing a user. In one or more embodiments, the electronic device includes at least one output device, a memory including a companion device update management module, and a communications subsystem that links the electronic device to a communication network including other electronic devices. A processor of the electronic device is communicatively coupled to the memory and the communications subsystem. The processor is configured to cause the electronic device to communicate with and manage, via the communications subsystem, an ecosystem of connected devices. The ecosystem of connected devices includes the electronic device configured as a first central hub, a first companion device, and a second electronic device. The processor is configured to cause the electronic device to receive a software update for the first companion device. The processor is configured to cause the electronic device to determine an installation time required to complete installation of the software update in the first companion device. The processor is configured to cause the electronic device to determine a context of usage of the first companion device, in part based on current and predicted usage of at least one of the first electronic device and the second electronic device. The context of usage indicates a likelihood of usage of the first companion device from a start time of the installation and during the installation time. The processor is configured to cause the electronic device to manage installation of the software update on the first companion device in response to determining the context of usage of the first companion device being less than a likelihood threshold. In one embodiment, the installation is scheduled for a time period during which the second electronic device is being used.

The present disclosure addresses a significant need in smart updating of companion devices. Timing software updates for companion devices is crucial to avoid disrupting their usage or availability when needed. Performing updates while these companion devices are in use or when likely to be used poses significant challenges. Unlike computers and smartphones, which have mechanisms for delaying updates until idle or not expected to be used, companion devices such as earphones often lack a capability for delayed updates since the host devices control the updates and not the companion devices themselves. Also, companion devices such Internet of Things (IoT) devices are designed for continuous use, with minimal downtime, making it difficult to find appropriate windows for updates. For example, consider wireless earphones. Users rely on them for activities such as listening to music during workouts or making calls throughout the day. Making the device unusable at an important time because a software update is ongoing is not an acceptable situation. Additionally, the limited battery life of such devices necessitates efficient use of available power since an update process can drain the battery, rendering the device unusable when needed most. The complexity increases as users accumulate multiple companion devices. Coordinating updates across various devices and users becomes a logistical challenge. Thus, there is a strong need for a solution that can manage updates by reliably identifying the optimal times for the updates without disrupting the critical functions of ecosystem devices.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined primarily by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

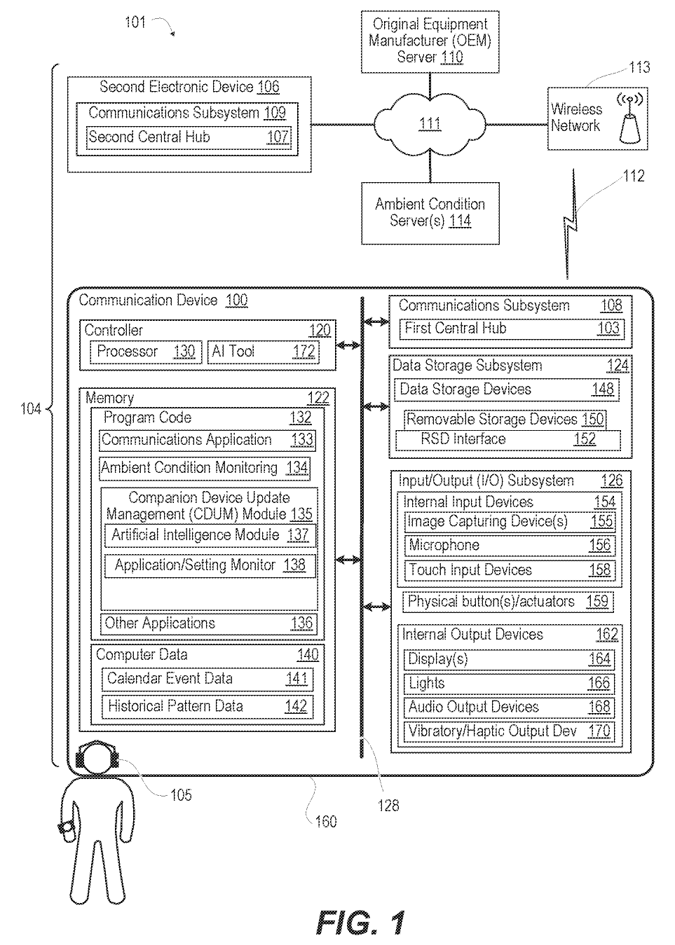

FIG. 1 presents a simplified functional block diagram of an electronic device in which the features of the present disclosure are advantageously implemented to update a companion device in a connected device ecosystem without inconveniencing a user. In particular, update scheduling is based on deterministic and/or predictive usage of the companion device during an update installation time. In one or more embodiments, the electronic device includes additional communications functionality that enables electronic device to be referred to as communication device 100, which operates as a mobile user device for user 102 in communication environment 101. Communication device 100 includes/provides functionality of first central hub 103 for connecting to other devices in ecosystem 104 of connected devices including first companion device 105, such as headphones or a smartwatch. For clarity, ecosystem 104 includes a second electronic device 106, which can have similar or identical components as described herein for communication device 100 or be differently configured. For example, second electronic device 106 includes/provides functionality of second central hub 107 that can connect to other devices in ecosystem 104 such as communication device 100 and first companion device 105. In one or more embodiments, central hub 103 provided by communication device 100 includes/incorporates at least part of communications subsystem 108. Second central hub 107 of second electronic device 106 includes/incorporates at least part of communications subsystem 109.

Communication device 100 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 100 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices.

In the specific example of FIG. 1, communication environment 101 also includes original equipment manufacturer (OEM) server 110 that provides software updates for first companion device 105 through communication network 111. Communications device 100 includes communications subsystem 108 that connects via wired or wireless channel 112 to node 113 (e.g., wireless access point, cellular tower) to communicatively connect to OEM server(s) 110 and second electronic device 106 via one or more communication network(s) generally presented as network(s) 111. Communication device 100 may connect to other remote services such as provided by ambient condition server(s) 114 for information regarding weather and traffic conditions.

Communication device 100 includes controller 120, memory 122, data storage subsystem 124 and input/output (I/O) subsystem 126. To enable management by controller 120, system interlink 128 communicatively connects controller 120 with communications subsystem 108, memory 122, data storage subsystem 124 and I/O subsystem 126. System interlink 128 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 128) are illustrated in FIG. 1, it is to be understood that more, fewer, or different interconnections may be present in other embodiments.

Controller 120 includes processor 130, which includes one or more central processing units (CPUs) or data processors. Processor 130 can include one or more digital signal processors and graphics processing units (GPUs), etc. that can be integrated with data processor(s). Processor 130 can include other processors such as auxiliary processor(s) that may act as a low power consumption, always-on sensor hub for physical sensors. Controller 120 manages, and in some instances directly controls, the various functions and/or operations of communication device 100. These functions and/or operations include, but are not limited to including, application data processing, communication, navigation tasks, image processing, and signal processing. In one or more alternate embodiments, communication device 100 may use hardware component equivalents for application data processing and signal processing. For example, communication device 100 may use special purpose hardware, dedicated processors, general purpose computers, microprocessor-based computers, micro-controllers, optical computers, analog computers, dedicated processors and/or dedicated hard-wired logic.

Memory 122 stores program code 132 for execution by processor 130 to provide the functionality described herein. Memory 122 further includes operating system (OS), firmware interface, such as basic input/output system (BIOS) or Uniform Extensible Firmware Interface (UEFI), and firmware, which also includes and may thus be considered as program code 132. Program code 132 includes applications such as communication application 133 for communicating with first companion device 105, second electronic device 106, and OEM server(s) 110. Program code 132 includes applications such as ambient condition monitor application 134 for receiving ambient conditions, via communications subsystem 108, from ambient condition server(s) 114. In an example, ambient conditions may include local weather and local traffic conditions that may affect usage of navigation and weather applications and may affect mode and duration of a commute. Companion device usage may correspond to changes in usage appropriate for the weather and commute patterns. In an example, a user may be unable to complete a commute in time for a calendar event, requiring use of a companion device connected with a smartphone to participate in a meeting or communication session. Program code 132 may include companion device update management (CDUM) module 135 managing update of first companion device 105. Program code 132 can also include other applications 136. CDUM module 135 may include artificial intelligence (AI) model 137 and application/setting monitor 138 for detecting usage and context of usage of devices of ecosystem 104. In one or more embodiments, several of the described aspects of the present disclosure are provided via executable program code of applications executed by controller 120. In one or more embodiments, program code 132 may be integrated into a distinct chipset or hardware module as firmware that operates separately from executable program code. Portions of program code 132 may be incorporated into different hardware components that operate in a distributed or collaborative manner.

Program code 132 may access, use, generate, modify, store, or communicate computer data 140, such as calendar event data 141 and historical pattern data 142 for CDUM module 135 to use in managing updates of companion devices. Computer data 140 may incorporate “data” that originated as raw, real-world “analog” information that consists of basic facts and figures. Computer data 140 includes different forms of data, such as numerical data, images, coding, notes, and financial data. Computer data 140 may originate at communication device 100 or be retrieved from a remote device via communications subsystem 108. Communication device 100 may store, modify, present, or transmit computer data 140, such as historical pattern data 142. Computer data 140 may be organized in one of a number of different data structures. Common examples of computer data 140 include video, graphics, text, and images. Computer data 140 can also be in other forms of flat files, databases, and other data structures.

Data storage subsystem 124 of communication device 100 includes data storage device(s) 148. Controller 120 is communicatively connected, via system interlink 128, to data storage device(s) 148. Data storage subsystem 124 provides program code 132 and computer data 140 stored on nonvolatile storage that is accessible by controller 120. For example, data storage subsystem 124 can provide a selection of program code 132 and computer data 140. These applications can be loaded into memory 122 for execution/processing by controller 120. In one or more embodiments, data storage device(s) 148 can include hard disk drives (HDDs), optical disk drives, and/or solid-state drives (SSDs), etc. Data storage subsystem 124 of communication device 100 can include removable storage device(s) (RSD(s)) 150, which is received in RSD interface 152. Controller 120 is communicatively connected to RSD 150, via system interlink 128 and RSD interface 152. In one or more embodiments, RSD 150 is a non-transitory computer program product or computer readable storage device that stores program code and/or instructions that may be executed by a processor associated with a user device such as communication device 100. Controller 120 can access data storage device(s) 148 or RSD 150 to provision communication device 100 with program code 132 and computer data 140.

I/O subsystem 126 may include internal input devices 154 such as image capturing device(s) 155, microphone 156, and touch input devices 158 (e.g., screens, keys, or buttons). I/O subsystem 126 may include physical buttons/actuators 159 that can be located on a periphery of the device housing 160. I/O subsystem 126 may include internal output devices 162 such as display(s) 164, lights 166, audio output devices 168, and vibratory or haptic output devices 170.

In one or more embodiments, CDUM module 135 includes AI model 137 that is trained to recognize historical patterns of usage of devices of ecosystem 104. In one or more embodiments, the historical pattern data 142 may initially be based on similarly disposed users in other ecosystems so that communication device 100 is provisioned at initial use. In one or more embodiments, the historical pattern data 142 is wholly based, or updates the provisioned data, based on usage and context of use by user 102. CDUM module 135 and AI model 137 may be stored in memory 122 of communication device 100 and be executed by controller 120 to perform various aspects of the functionality of the present disclosure. Training of AI model 137 is the process by which AI models are trained to perform specific tasks or achieve certain objectives. The training involves providing the model with a large amount of data and allowing the model to learn from patterns and relationships within that data. Controller 120 may include various functionalities, such as an integrated AI tool 172, that enable controller 120 to perform different aspects of AI models. AI models may include an artificial neural network, a decision tree, a support vector machine, Hidden Markov model, linear regression, logistic regression, Bayesian networks, and so forth. The AI models can be individually trained to perform specific tasks and can be arranged in different sets of AI models to generate different types of output.

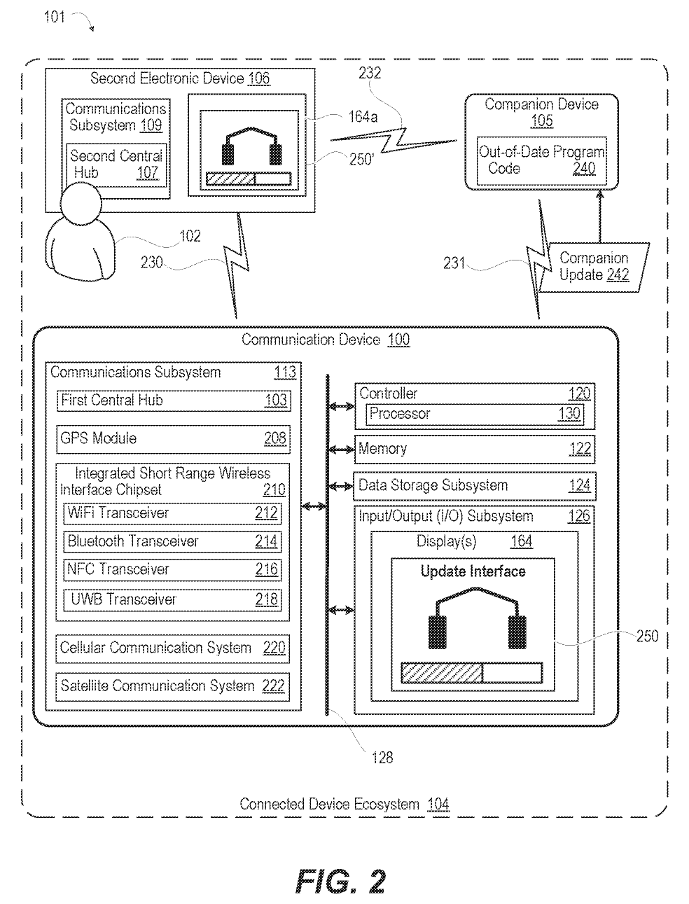

FIG. 2 is a simplified block diagram of communication device 100 having additional communication interfaces for wireless communications within connected device ecosystem and with other devices. In one or more embodiments, controller 120, via communications subsystem 108, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 108 includes a global positioning system (GPS) module 208 that receives GPS broadcasts from GPS satellites to obtain geospatial location information. In one or more embodiments, controller 120, via communications subsystem 108, communicates via a wireless local area network (WLAN) link using one or more IEEE 802.11 WLAN protocols with an access point. In one or more embodiments, controller 120, via communications subsystem 108, may communicate via an OTA cellular connection with radio access networks (RANs). In an example, communication device 100, via communications subsystem 108, connects via RANs of a terrestrial network that is communicatively connected to a network server. In one or more embodiments, communications subsystem 108 includes integrated short range wireless interface chipset 210 having one or more of Wi-Fi component 212, Bluetooth (BT) transceiver (TxRx) 214, near field communication (NFC) transceiver 216, and ultra-wideband transceiver 218. In one or more embodiments, communications subsystem 108 further includes long distance communication capabilities including cellular communication system 220 and satellite communication system 222.

Communication device 100 may communicate with first companion device 105 and second electronic device 106 directly or indirectly respectively via communication link 230 and 231 using one or more wired or wireless capabilities of communications subsystem 108. Second electronic device 106 may similarly communicate with first companion device 105 via communication link 232. In an example, first companion device 105 may have out-of-date program code 240. Communication device 100 communicates companion update program code 242 via communication link 230. When installation of companion update program code 242 is underway, communication device 100 presents companion update interface 250 on display(s) 164. Communication device 100 may communicate a copy of update interface 250′ to second electronic device 106 for presenting on display(s) 164a. In one or more embodiments, communication device 100 communicates the copy of update interface 250′ when communication device 100 is connected to second electronic device 106 and while second electronic device 106 is being used by user 102.

With reference again to FIG. 1, according to aspects of the present disclosure, an electronic device such as communication device 100 includes at least one output device 162, memory 122 including CDUM module 135, and communications subsystem 108 that links communication device 100 to communication network 111 including other electronic devices. Processor 130 of communication device 100 is communicatively coupled to memory 122 and communications subsystem 108. Processor 130 is configured to cause communication device 100 to communicate with and manage, via communications subsystem 108, ecosystem 104 of connected devices including communication device 100 configured as first central hub 103, first companion device 105, and second electronic device 106. Processor 130 is configured to cause communication device 100 to receive a software update for first companion device 105. Processor 130 is configured to cause communication device 100 to determine an installation time required to complete installation of the software update in first companion device 105. Processor 130 is configured to cause communication device 100 to determine a context of usage of first companion device 105, in part based on current and predicted usage of at least one of communication device 100 and second electronic device 106. The context of usage indicates a likelihood of usage of first companion device 105 from a start time of the installation and during the installation time. Processor 130 is configured to cause communication device 100 to manage installation of the software update on first companion device 105 in response to determining the context of usage of first companion device 105 is less than a likelihood threshold, which correlates with a time period during which second electronic device 106 is being used.

In one or more embodiments, processor 130 is configured to cause communication device 100 to initiate installation of the software update on first companion device 105 at least in part in response to determining a time period during which the second electronic device is being used, first companion device 105 is connected to communication device 100, and first companion device 105 is not connected to second electronic device 106.

In one or more embodiments, second electronic device 106 is configured as second central hub 107 of connected devices ecosystem 104. Processor 130 is configured to cause communication device 100 to generate and present update interface 250 (FIG. 2) on the at least one output device 162 presenting a status of the update. Processor 130 is configured to cause communication device 100 to transmit a copy of update interface 250′ (FIG. 2) via communications subsystem 108 to second electronic device 106 to concurrently present the status of the update. In one or more embodiment, processor 130 is configured to cause communication device 100 to determine that the likelihood of usage is less than the likelihood threshold in response to determining that second electronic device 106 is in use by user 102 and that first companion device 105 is not in use. In one or more embodiment, processor 130 is configured to cause communication device 100 to determine that the likelihood of usage is greater than or equal to the likelihood threshold in response to determining at least one calendar event is scheduled during a period of time corresponding to the installation time. In one or more embodiments, analysis of historical usage for similar calendar events determines a correlation with usage of particular companion devices. A calendar event that has a strong positive correlation with the companion device indicates a likelihood of future use. For other calendar events or for other companion devices, there may be neutral correlation (i.e., indeterminant of being used) or a negative correlation (i.e., unlikely to be used) respectively with different types of companion devices. Alternatively, or in addition, certain categories of calendar events may be designated as needing a particular companion device. In an example, a user or OEM may designate the need for a companion device with a microphone or wearable earphones when the primary or secondary electronic device being used does not include integral microphone or speakers.

In one or more embodiments, processor 130 is configured to cause communication device 100 to predict the likelihood of usage of the first companion device based on a current context during a period of time corresponding to the installation time and correlating to at least one historical pattern of usage of the companion device. In one or more particular embodiments, in predicting the likelihood of usage of first companion device 105, processor 130 is configured to cause communication device 100 to determine the current context from at least an ambient condition including one or more of weather and traffic during the period of time. In an example, processor 130 is configured to cause communication device 100 to receive, via communications subsystem 108, ambient conditions from ambient condition server(s) 114. Processor 130 is configured to cause communication device 100 to correlate the likelihood of usage of first companion device 105 to the at least one historical pattern of usage of first companion device 105 in a similar context of the at least one ambient condition. In one or more particular embodiments, the at least one historical pattern includes one or more pattern from among a group comprising: (i) application usage pattern; (ii) setting and preferences; (iii) messaging and calling pattern; (iv) charging pattern; (v) social media activity pattern; and (vi) shared device usage pattern.

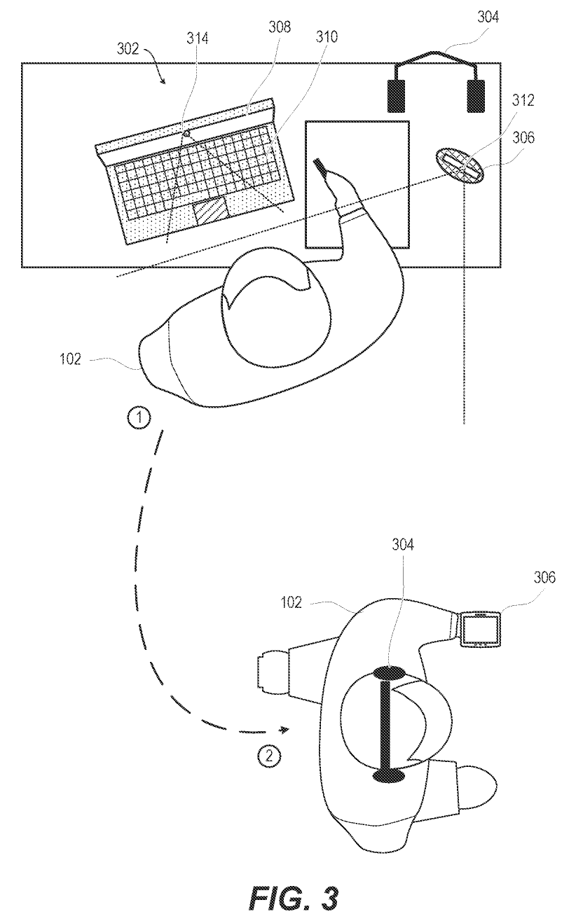

FIG. 3 is a top view of example connected device ecosystem 302 having companion device depicted as headphones 304 that are initially not being used in a first scenario “1” and are then being used in a subsequent second scenario “2”. In the first scenario, ecosystem 302 includes a primary device, depicted as smartphone 306, that is connected to a secondary device, depicted as laptop 308. Smartphone 306 and laptop 308 may be configured identically or similarly to communication device 100 of FIG. 1, although they may also be differently configured, but operable as a first and a second central hub. While in first scenario, User 102 is paying attention to laptop 308, and user’s engagement with laptop may be detected based on inputs to keyboard 310 of laptop 308 or by detecting eye gaze direction using camera 312 of smartphone 306 or camera 314 of laptop 308. Without benefits of the present disclosure, when smartphone 306 receives a companion device update, smartphone 306 may start installation of the update on headphones 304 regardless of whether user 102 will subsequently transition to the second scenario of carrying smartphone 306 while wearing and using headphones 304. User 102 may need to use headphones 304, for example, to participate in an audio or video session while not disturbing others or not allowing others to overhear content of the session.

With the benefit of the present disclosure, smartphone 306 may determine that the first scenario is scheduled to continue, or that a historical pattern of usage indicates a high likelihood that the first scenario can be predicted to continue, for a period of time required for installation of the software update/download to the companion device, enabling the installation to be initiated. Conversely, smartphone 306 may determine that the first scenario is not scheduled to continue, or that a historical pattern of usage indicates a high likelihood that the second scenario can be predicted to occur, within the period of time required for installation completion, requiring a delay in initiation of the installation of the update.

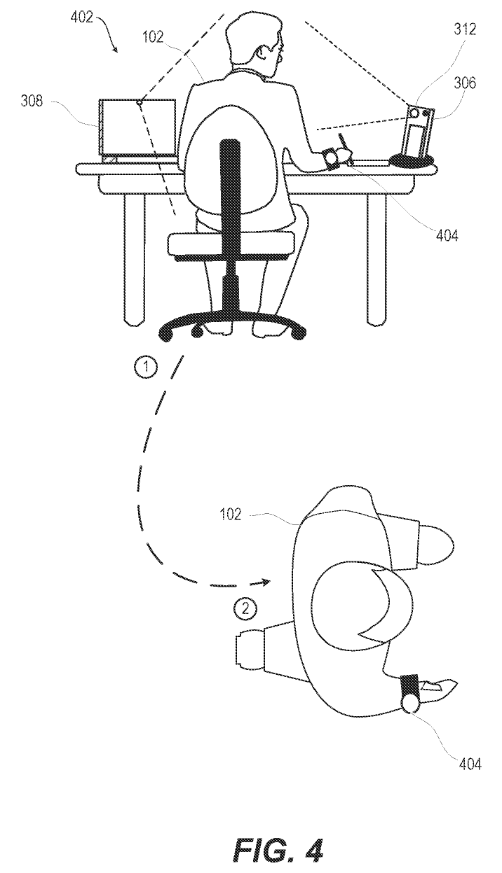

FIG. 4 is a front view of another example connected device ecosystem 402 that includes smartwatch 404 as a companion device that is not in use in a first scenario “1” and is in use in a second scenario “2”, with the historical or predicted usage data for the companion device affecting timing of a software update. In the first scenario, ecosystem 402 also includes smartphone 306 and laptop 308, respectively operating as first and second central hub. User 102 may depend on using smartwatch 404 for measuring exercise parameters (e.g., heart rate) or as a more accurate motion sensor for distance and speed. With the benefit of the present disclosure, smartphone 306 initiates updating of smartwatch 404 when the smartphone determines or predicts that the update will not interfere with user 102 changing to the subsequent second scenario when carrying smartphone 306 and using smartwatch 404.

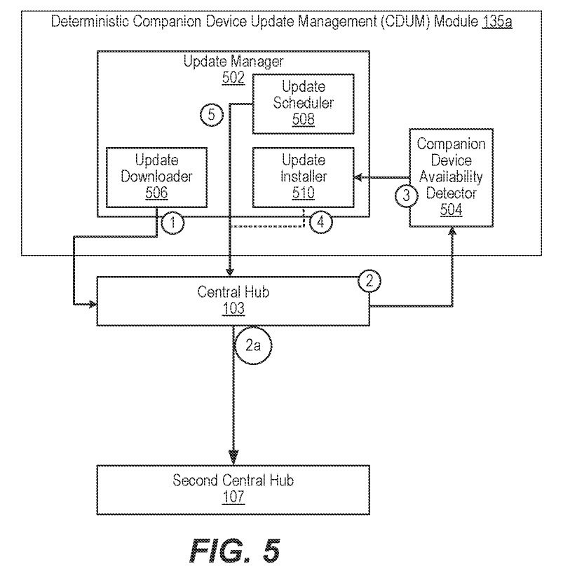

FIG. 5 is a processing diagram of deterministic companion device update management (CDUM) module 135a interacting with first central hub 103 of communication device 100 (FIG. 1). In an example, deterministic CDUM module 135a includes an update manager 502 and companion device availability detector 504. Update manager 502 includes update downloader 506, update scheduler 508, and update installer 510. At a first time “1”, in response to update downloader 506 receiving an update for a companion device, update downloader 506 accesses first central hub 103 to determine a connection and usage status of companion device within ecosystem 104 (FIG. 1). At a second time “2”, first central hub 103 communicates connectivity status and availability to companion device availability detector 504. Alternatively, or in addition, at a second time “2A”, first central hub 103 determines whether a connection exists with second central hub 107. At third time “3”, if conditions are deterministically correct (e.g., user using secondary device and not using companion device), companion device availability detector 504 triggers update installer 510 at fourth time “4” to install the update via first central hub 103. If, however, at third time “3” conditions are not deterministically correct, update scheduler 508 is triggered to reschedule, via first central hub 103, the update to when conditions are deterministically correct.

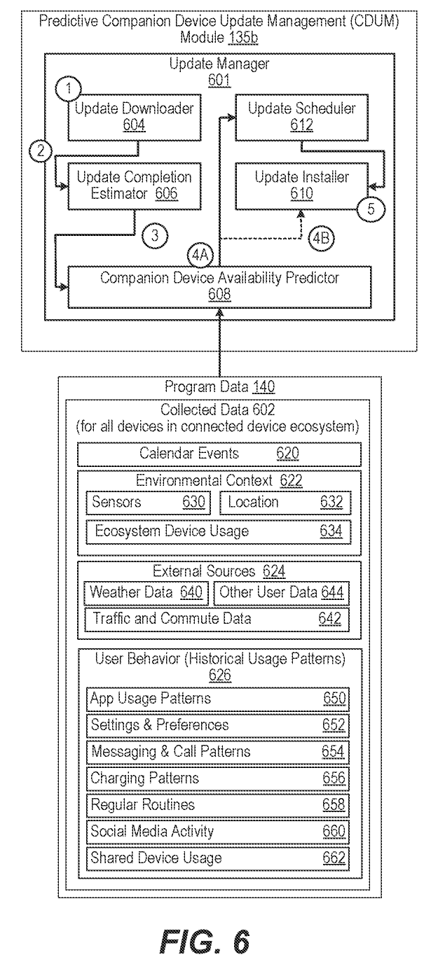

FIG. 6 is a processing diagram of predictive CDUM module 135b having update manager 601 utilizing collected data 602 on context and user behavior, which may be stored as program data 140 on communication device 100 (FIG. 1), to predictively schedule updating of a companion device. In one or more embodiments, update manager 601 includes update downloader 604, update completion estimator 606, companion device availability predictor 608, update installer 610, and update scheduler 612. At a first time “1”, update downloader 604 receives an update. At second time “2”, update downloader 604 communicates the update to update completion estimator 606 that determines a period of time required to perform the installation. At third time “3”, update completion estimator 606 communicates the period of time required to companion device availability predictor 608 to determine likelihood of usage of the companion device during the period of time, using collected data 602 (described hereafter). If the likelihood is high, at one fourth time “4A”, update scheduler 612 is activated to delay installation. Then, at a fifth time “5”, update installer 610 delays/defers the installation of the update on the companion device to a later scheduled time. If the likelihood is low, at an alternate fourth time “4B”, update installer 610 is immediately activated to install the update on the companion device.

Collected data 602 may include calendar events 620, environmental context data 622, external sources data 624, and user behavior data 626 (e.g., historical usage patterns). Environmental context data 622 may include sensor data 630, location data 632, and ecosystem device usage data 634. External sources data 624 may include weather data 640, traffic and commute data 642, and other user data 644. User behavior data 626 may include application (“app”) usage patterns 650, settings and preferences 652, messaging and call patterns 654, charging patterns 656, regular routines 658, social media activity 660, and shared device usage 662.

Calendar data 602 may include a schedule of upcoming appointments or events (e.g., meetings, workouts, concerts) that are associated with potential device usage. In an example, a meeting might predict headset usage, while a concert might predict the use of smart glasses for an immersive experience.

Environmental context data 622 are factors that relate to the immediate environment and circumstances surrounding the user, providing real-time signals about potential device usage. Sensor data 630 may include temperature, humidity, and light that are captured by corresponding sensors and that can provide context about the environment, such as whether user is indoors or outdoors. In an example, certain companion devices may have displays that are easily seen in bright sunshine and tend to be used indoors. Conversely, smart glasses may be appropriate for navigation outdoors. Sensor data 630 may include motion sensors such as accelerometers and gyroscopes in smartphones and wearables that can detect user activity (e.g., walking, running, stationary), which can predict device usage patterns (e.g., listening to music while running).

Another type of environmental context data 622 is location data 632, such as global position system (GPS) data, which can provide valuable context about the user's surroundings (e.g., at home, work, gym, etc.). Location data 632 may also be combined with historical patterns to predict device usage. In an example, a user might be more likely to use a Bluetooth headset in a gym or a smartwatch in a park based on past usage.

Ecosystem device usage data 634 is based on device-to-device communication. This type of environmental context data 622 may track pairing patterns and usage triggers. In an example, ecosystem device usage data 634 may include a smartphone connecting to a Bluetooth headset when the user enters their car, which may predict that the user is about to start a phone call or listen to audio. The ecosystem may be configured to prepare relevant apps or services in response to the connection of the Bluetooth headset.

External sources data 624 describes factors that are external to the user and their devices but can still provide valuable insights into potential usage patterns based on broader context and trends. First, weather data 640 includes weather conditions (e.g., rain, temperature) that may influence device usage. For example, rainy weather might predict increased usage of indoor devices like smart speakers or smart displays. Second, traffic and commute data 642 is real-time traffic updates that can affect how and when users interact with their devices. In an example, extended use of particular devices for navigation and communication historically has occurred during a commute.

Other user data 644 includes external user data, sources and technologies such as cohort analysis and market trends. External data sources and technologies like collaborative filtering may be used to analyze usage patterns across multiple users. The external usage patterns may predict, or assist in predicting, device or feature usage for user 102 (FIG. 1) based on similar user behaviors. For instance, if many users pair their smartwatches with specific Bluetooth headsets for workouts, this usage pattern can be inferred for others. Other user data 644 may include context-aware computing and machine learning. Understanding the user's context (i.e., combining location, activity, time of day, etc.) can be used to predict device usage, based on learning from analyzing historical usage patterns in combination with real-time sensor data and contextual cues. These models can learn complex patterns and adapt to individual user preferences.

User behavior data 626 may include a group of data types that encompass the individual's actions, preferences, and habits that directly influence device usage. Application (“app”) usage patterns 650 may include monitoring usage frequency, duration, and time of day to enable predicting future use. For example, if a user consistently uses a meditation app on their smartwatch every evening, then a prediction of a high likelihood of usage may be made with a high confidence level. Conversely, if a user inconsistently uses a meditation app on their smartwatch each evening, then a prediction of a low or moderate likelihood of usage may be made with a low or moderate confidence level depending on the frequency. Current or recently used apps can indicate what a user might do next. For instance, if a user is currently using a navigation app, they might continue to use smart glasses for directions. User behavior data 626 may include settings and preferences 652 such as do-not-disturb schedules, which may predict when devices will be used or remain idle. Messaging and call patterns 654 may include frequent interactions with certain contacts that can indicate expected device usage. For example, regular evening calls with family may predict use of the same companion device during a future evening call. Charging patterns 656, regular routines 658, and social media activity 660 may have similar associations.

Shared device usage 662 is based on having multiple users for the same device. Recognizing patterns where multiple users share the same device, such as a smart TV or a shared Bluetooth used by different family members at different times of the day, can be used to predict if someone is likely to use the shared device next.

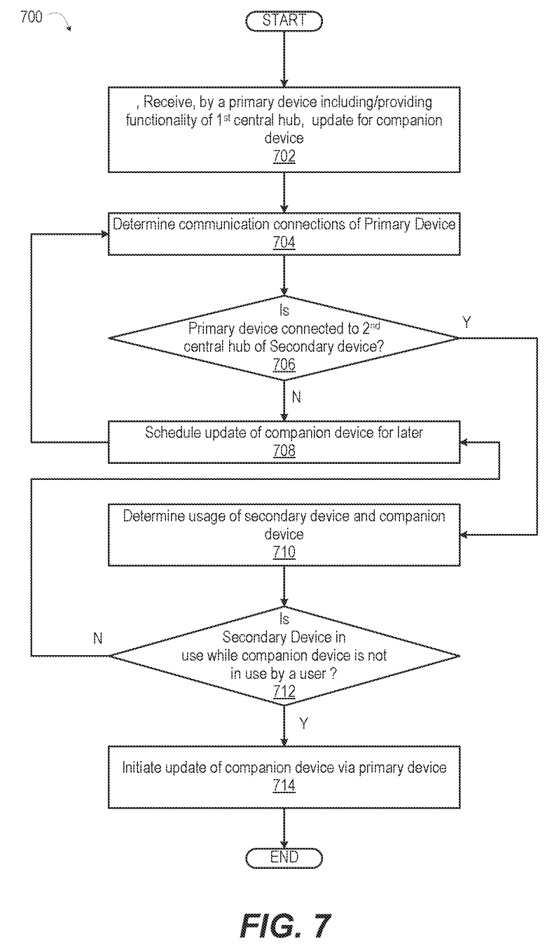

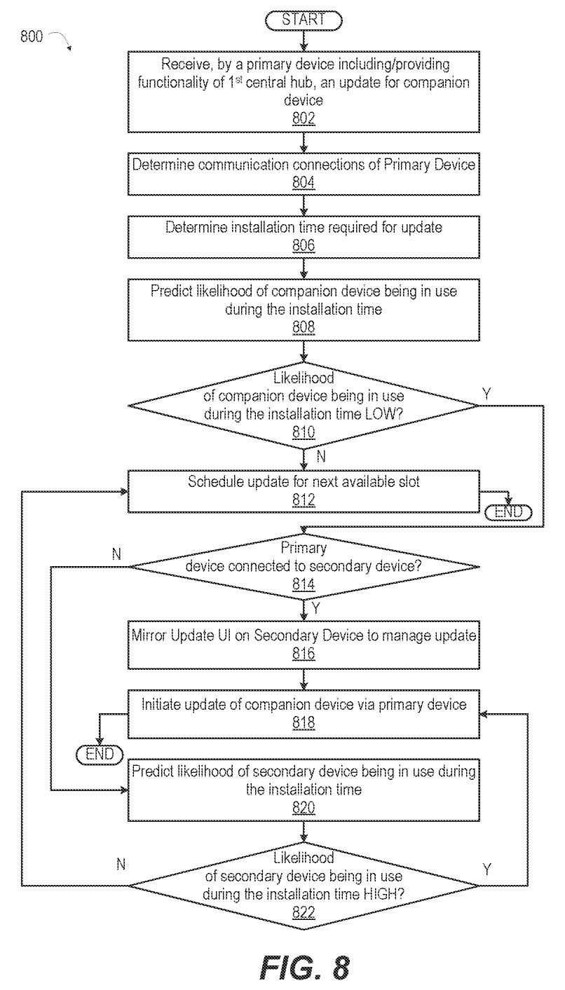

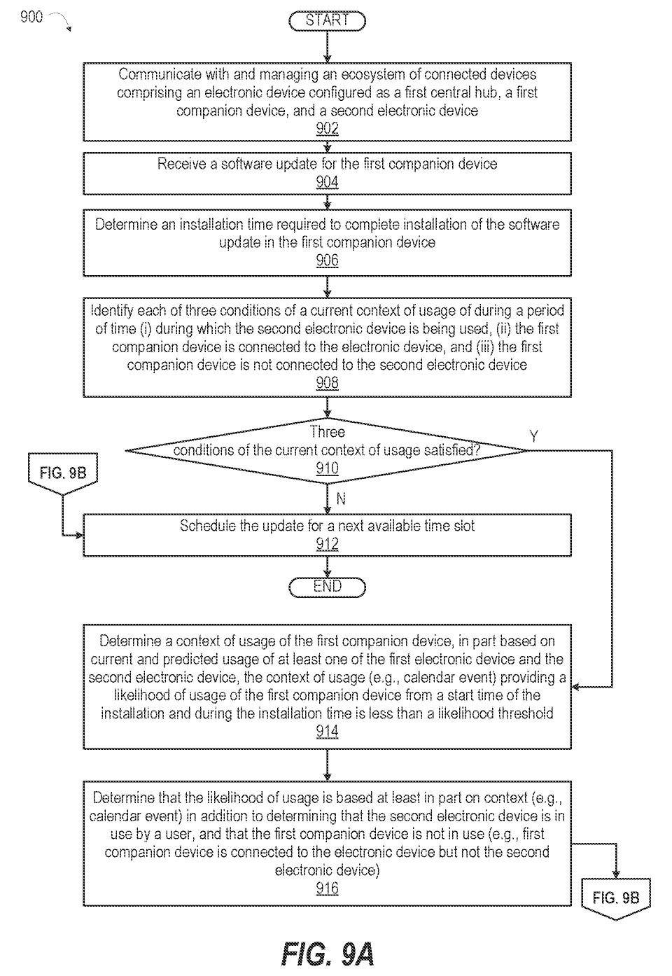

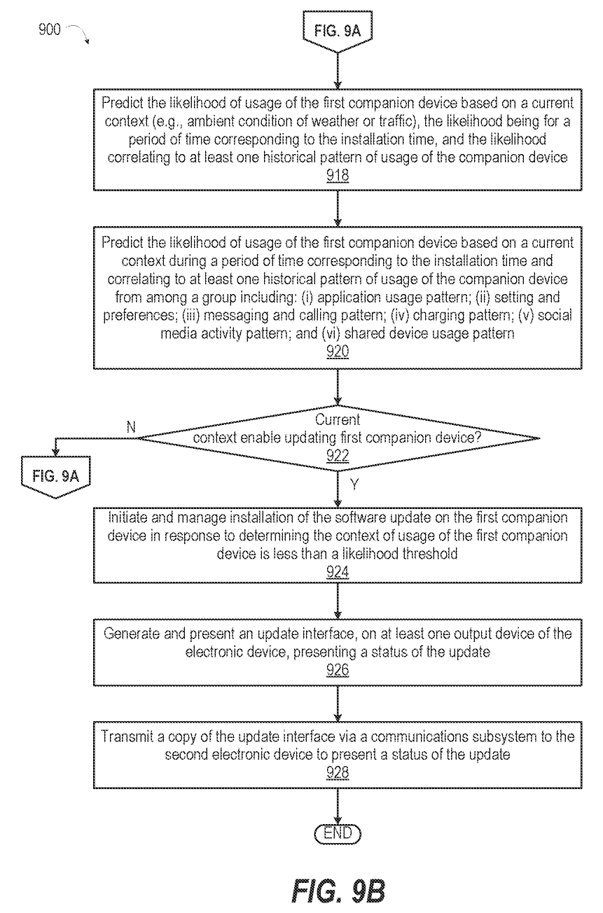

FIG. 7 is a flow diagram presenting method 700 for deterministically managing a companion device update. FIG. 8 is a flow diagram presenting method 800 for predictively managing a companion device update, according to one or more embodiments. FIGS. 9A-9B (collectively “FIG. 9”) are a flow diagram presenting method 900 for updating a companion device in a connected device ecosystem without inconveniencing a user. The description of method 700, (FIG. 7), method 800 (FIG. 8) and method 900 (FIG. 9) are provided with general reference to the specific components illustrated within the preceding FIGS. 1-6. Specific components referenced in method 700, (FIG. 7), method 800 (FIG. 8) and method 900 (FIG. 9) may be identical or similar to components of the same name used in describing preceding FIGS. 1 –6. In one or more embodiments, controller 120 (FIG. 1) configures communication device 100 (FIG. 1) or a similar computing device to provide the described functionality of method 700, (FIG. 7), method 800 (FIG. 8), and method 900 (FIG. 9).

With reference to FIG. 7, method 700 includes receiving, by a primary device operating as a first central hub in a connected device ecosystem, an update for a companion device (block 702). Method 700 includes determining communication connections of the primary device (block 704). Method 700 includes determining whether the primary device is connected to a secondary device operating as a second central hub of the connected device ecosystem (decision block 706). In response to determining that the primary device is not connected to a second central hub (provided by a secondary device), method 700 includes scheduling update of the companion device for a later time (block 708). The second device may be offline or off, so not able to be found within the ecosystem. Then method 700 returns to block 704. In response to determining that the primary device is connected to the second central hub of the connected device ecosystem, method 700 include determining usage of the secondary device and companion device (block 710). Method 700 includes determining whether the secondary device is in use while the companion device is not in use by a user (decision block 712). In response to determining that secondary device is not in use and/or the companion device is in use, method 700 returns to block 708. In response to determining that the secondary device is in use while the companion device is not in use by a user, method 700 includes initiating update of the companion device via the primary device (block 714). Then method 700 ends.

With reference to FIG. 8, method 800 includes receiving, by a primary device that includes/provides function of a first central hub, an update for a companion device (block 802). Method 800 includes determining communication connections of the primary device (block 804). Method 800 includes determining installation time required for the update (block 806). Method 800 includes predicting the likelihood of the companion device being placed in use during the installation time (block 808). Method 800 includes determining whether the likelihood of the companion device being placed in use during the installation time is low (e.g., below a threshold percentage) (decision block 810). In response to determining that the likelihood of the companion device being in use during the installation time is not low, method 800 includes scheduling/pushing the software update for the next available slot (block 812). In an example, the usage patterns and defined calendar events may indicate a subsequent period of time of sufficient duration to accomplish the installation. A future slot may be defined within the subsequent period of time. Then method 800 ends. In response to determining that the likelihood of the companion device being in use during the installation time is low, method 800 includes initiating update of the companion device via the primary device (block 814). Method 800 includes determining whether the primary device is connected to the secondary device (decision block 816). In response to determining that the primary device is connected to the secondary device, method 800 includes mirroring an update user interface (UI) on the secondary device to manage the update (block 818). Then method 800 ends. In response to determining that the primary device is not connected to the secondary device in decision block 814, method 800 includes predicting the likelihood of the secondary device being in use during the installation time (block 820). Method 800 includes determining whether the predicted likelihood of secondary device being in use during the installation is high (decision block 822). In response to determining that the predicted likelihood of the secondary device being in use during the installation is high, method 800 returns to block 818. In response to determining that the predicted likelihood of the secondary device being in use during the installation is not high, method 800 returns to block 812.

With reference to FIG. 9A, method 900 includes communicating with and managing an ecosystem of connected devices that includes an electronic device configured as a first central hub, a first companion device, and a second electronic (block 902). Method 900 includes receiving a software update for the first companion device (block 904). Method 900 includes determining an installation time required to complete installation of the software update in the first companion device (block 906). Method 900 includes identifying each of three conditions of a current context of usage of during a period of time (i) during which the second electronic device is being used, (ii) the first companion device is connected to the electronic device, and (iii) the first companion device is not connected to the second electronic device (block 908). Method 900 includes determining whether the three conditions of the current context of usage are satisfied (decision block 910). In response to determining that the three conditions of the current context of usage during the period of time are not satisfied, method 900 may include scheduling the update for a next available time slot (block 912). Then method 900 ends.

In one or more embodiments, method 900 may initiate installation of the software update based solely on determining that the three conditions of the current context of usage during the period of time are satisfied. Alternatively, method 900 may initiate installation of the software update further solely based on predicted context of usage of the ecosystem of connected devices. Alternatively, and as depicted, in response to determining that the three conditions of the current context of usage during the period of time are satisfied in decision block 910, method 900 may include determining a context of usage of the first companion device, in part based on current and predicted usage of at least one of the first electronic device and the second electronic device (block 914). The context of usage indicates a likelihood of usage of the first companion device from a start time of the installation and during the installation time being less than a likelihood threshold. In one embodiment, method 900 includes determining that the likelihood of usage is based at least in part on context (e.g., calendar event) in addition to determining that the second electronic device is in use by a user, and that the first companion device is not in use (e.g., the first companion device is connected to the electronic device but not the second electronic device) (block 916).

With reference to FIG. 9B, alternatively, or in addition, in one or more embodiments, method 900 includes predicting the likelihood of usage of the first companion device based at least in part on a current context (e.g., ambient condition of weather or traffic). The likelihood is determined for a period of time corresponding to the installation time. The likelihood correlates to at least one historical pattern of usage of the companion device (block 918).

alternatively, or in addition, in one or more embodiments, method 900 includes predicting the likelihood of usage of the first companion device based on a current context during a period of time corresponding to the installation time and correlating to at least one historical pattern of usage of the companion device from among a group including: (i) application usage pattern; (ii) setting and preferences; (iii) messaging and calling pattern; (iv) charging pattern; (v) social media activity pattern; and (vi) shared device usage pattern (block 920). In one or more embodiments, a historical pattern is determined at an original equipment manufacturer (OEM) such as being based on data received from other users in similar contexts. In one or more embodiments, a historical pattern is learned or updated based on a monitoring usage by a user of the electronic device, the second electronic device, and the first companion device.

With continued reference to FIG. 9B, method 900 includes determining whether the current context enables updating the first companion device (decision block 922). In response to determining that the current context does not enable updating the first companion device, method 900 includes rescheduling the update by returning to block 912 (FIG. 9A). In response to determining that the current context enables updating the first companion device in decision block 922, method 900 includes initiating and managing installation of the software update on the first companion device in response to determining the context of usage of the first companion device is less than a likelihood threshold (block 924). Method 900 includes generating and presenting an update interface, on at least one output device of the electronic device, presenting a status of the update (block 926). Method 900 includes transmitting a copy of the update interface via a communications subsystem to the second electronic device to present a status of the update (block 928). Then method 900 ends.

According to aspects of the present disclosure, method 900 may include communicating with and managing an ecosystem of connected devices comprising an electronic device configured as a first central hub, a first companion device, and a second electronic device. Method 900 may include receiving a software update for the first companion device. Method 900 may include determining an installation time required to complete installation of the software update in the first companion device. Method 900 may include determining a context of usage of the first companion device, in part based on current and predicted usage of at least one of the first electronic device and the second electronic device. The context of usage indicates a likelihood of usage of the first companion device from a start time of the installation and during the installation time. Method 900 includes managing installation of the software update on the first companion device in response to determining the context of usage of the first companion device being less than a likelihood threshold, corresponding at least in part to a time period during which the second electronic device is being used and the electronic device is not being used.

In one or more embodiments, method 900 may further include initiating installation of the software update on the first companion device at least in part in response to determining a time period during which the second electronic device is being used, the first companion device is connected to the electronic device, and the first companion device is not connected to the second electronic device. In one or more embodiments, the second electronic device is configured as a second central hub of the connected devices ecosystem. Method 900 may further include generating and presenting an update interface, on at least one output device of the electronic device, presenting a status of the update. Method 900 may further include transmitting a copy of the update interface via a communications subsystem to the second electronic device to concurrently present the status of the update.

In one or more embodiments, method 900 may further include determining that the likelihood of usage is less than the likelihood threshold in response to determining that the second electronic device is in use by a user and that the first companion device is not in use. In one or more embodiments, method 900 may further include determining that the likelihood of usage is greater than or equal to the likelihood threshold in response to determining at least one calendar event is scheduled during a period of time corresponding to the installation time.

In one or more embodiments, method 900 may further include predicting the likelihood of usage of the first companion device based on a current context during a period of time corresponding to the installation time and correlating to at least one historical pattern of usage of the companion device. In one or more particular embodiments, method 900 may further include predicting the likelihood of usage of the first companion device further by: (i) determining the current context from at least an ambient condition comprising one or more of weather and traffic during the period of time; and (ii) correlating the likelihood of usage of the first companion device to the at least one historical pattern of usage of the companion device in a similar context of the at least one ambient condition. In one or more particular embodiments, the at least one historical pattern includes one or more pattern from among a group comprising: (i) application usage pattern; (ii) setting and preferences; (iii) messaging and calling pattern; (iv) charging pattern; (v) social media activity pattern; and (vi) shared device usage pattern.

According to aspects of the present disclosure, the communication device 100 (FIG. 1), method 700 (FIG. 7), method 800 (FIG. 8), method 900 (FIG. 9) and computer program product, such as RSD 150 (FIG. 1), provide updating a companion device in a connected device ecosystem without inconveniencing a user by determining or predicting whether the companion device will be in use during an installation period of time. The present disclosure addresses coordinating updates across various devices and users, overcoming a logistical challenge. The present disclosure provides a solution for managing updates by reliably identifying the optimal times for the updates without disrupting the critical functions of connected ecosystem devices.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms "a", "an" and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one output device;
a memory comprising a companion device update management module;
a communications subsystem that links the electronic device to a communication network comprising other electronic devices; and
a processor communicatively coupled to the memory and the communications subsystem, and which is configured to cause the electronic device to:
communicate with and manage, via the communications subsystem, an ecosystem of connected devices comprising the electronic device configured as a first central hub, a first companion device, and a second electronic device;
receive a software update for the first companion device;
determine an installation time required to complete installation of the software update in the first companion device;
determine a context of usage of the first companion device, in part based on current and predicted usage of at least one of the first electronic device and the second electronic device, the context of usage indicating a likelihood of usage of the first companion device from a start time of the installation and during the installation time; and
manage installation of the software update on the first companion device in response to determining the context of usage of the first companion device is less than a likelihood threshold.

2. The electronic device of claim 1, wherein the processor is configured to cause the electronic device to:
initiate installation of the software update on the first companion device at least in part in response to determining a time period during which the second electronic device is being used, the first companion device is connected to the electronic device, and the first companion device is not connected to the second electronic device.

3. The electronic device of claim 1, wherein the second electronic device is configured as a second central hub of the connected devices ecosystem and the processor is configured to cause the electronic device to:
generate and present an update interface on the at least one output device presenting a status of the update; and
transmit a copy of the update interface via the communications subsystem to the second electronic device to concurrently present the status of the update.

4. The electronic device of claim 1, wherein the processor is configured to cause the electronic device to:
determine that the likelihood of usage is less than the likelihood threshold in response to determining that the second electronic device is in use by a user, and that the first companion device is not in use.

5. The electronic device of claim 1, wherein the processor is configured to cause the electronic device to:
determine that the likelihood of usage is greater than or equal to the likelihood threshold in response to determining at least one calendar event is scheduled during a period of time corresponding to the installation time.

6. The electronic device of claim 1, wherein the processor is configured to cause the electronic device to predict the likelihood of usage of the first companion device based on a current context during a period of time corresponding to the installation time and correlating to at least one historical pattern of usage of the companion device.

7. The electronic device of claim 6, wherein, in predicting the likelihood of usage of the first companion device, the processor is configured to cause the electronic device to:
determine the current context from at least an ambient condition comprising one or more of weather and traffic during the period of time; and
correlate the likelihood of usage of the first companion device to the at least one historical pattern of usage of the companion device in a similar context of the at least one ambient condition.

8. The electronic device of claim 6, wherein the at least one historical pattern comprises one or more pattern from among a group comprising: (i) application usage pattern; (ii) setting and preferences; (iii) messaging and calling pattern; (iv) charging pattern; (v) social media activity pattern; and (vi) shared device usage pattern.

9. A method comprising:
communicating with and managing an ecosystem of connected devices comprising an electronic device configured as a first central hub, a first companion device, and a second electronic device;
receiving a software update for the first companion device;
determining an installation time required to complete installation of the software update in the first companion device;
determining a context of usage of the first companion device, in part based on current and predicted usage of at least one of the first electronic device and the second electronic device, the context of usage providing a likelihood of usage of the first companion device from a start time of the installation and during the installation time; and
managing installation of the software update on the first companion device in response to determining the context of usage of the first companion device is less than a likelihood threshold.

10. The method of claim 9, further comprising:
initiating installation of the software update on the first companion device at least in part in response to determining a time period during which the second electronic device is being used, the first companion device is connected to the electronic device, and the first companion device is not connected to the second electronic device.

11. The method of claim 9, wherein the second electronic device is configured as a second central hub of the connected devices ecosystem, and the method further comprises:
generating and presenting an update interface, on at least one output device of the electronic device, presenting a status of the update; and
transmitting a copy of the update interface via a communications subsystem to the second electronic device to concurrently present the status of the update.

12. The method of claim 9, further comprising:
determining that the likelihood of usage is less than the likelihood threshold in response to determining that the second electronic device is in use by a user, and that the first companion device is not in use.

13. The method of claim 9, further comprising:
determining that the likelihood of usage is greater than or equal to the likelihood threshold in response to determining at least one calendar event is scheduled during a period of time corresponding to the installation time.

14. The method of claim 9, further comprising predicting the likelihood of usage of the first companion device based on a current context during a period of time corresponding to the installation time and correlating to at least one historical pattern of usage of the companion device.

15. The method of claim 14, wherein predicting the likelihood of usage of the first companion device further comprises:
determining the current context from at least an ambient condition comprising one or more of weather and traffic during the period of time; and
correlating the likelihood of usage of the first companion device to the at least one historical pattern of usage of the companion device in a similar context of the at least one ambient condition.

16. The method of claim 14, wherein the at least one historical pattern comprises one or more pattern from among a group comprising: (i) application usage pattern; (ii) setting and preferences; (iii) messaging and calling pattern; (iv) charging pattern; (v) social media activity pattern; and (vi) shared device usage pattern.

17. A computer program product comprising:
a computer readable storage device; and
program code on the computer readable storage device that when executed by a processor associated with an electronic device, the program code is configured to cause the electronic device to provide functionality of:
communicating with and managing an ecosystem of connected devices comprising the electronic device configured as a first central hub, a first companion device, and a second electronic device;
receiving a software update for the first companion device;
determining an installation time required to complete installation of the software update in the first companion device;
determining a context of usage of the first companion device, in part based on current and predicted usage of at least one of the first electronic device and the second electronic device, the context of usage providing a likelihood of usage of the first companion device from a start time of the installation and during the installation time; and
managing installation of the software update on the first companion device in response to determining the context of usage of the first companion device is less than a likelihood threshold.

18. The computer program product of claim 17, wherein the program code is further configured to cause the electronic device to provide functionality of:
initiating installation of the software update on the first companion device at least in part in response to determining a time period during which the second electronic device is being used, the first companion device is connected to the electronic device, and the first companion device is not connected to the second electronic device.

19. The computer program product of claim 17, wherein the second electronic device is configured as a second central hub of the connected devices ecosystem, and the program code is further configured to cause the electronic device to provide functionality of:
generating and presenting an update interface, on at least one output device of the electronic device, presenting a status of the update; and
transmitting a copy of the update interface via a communications subsystem to the second electronic device to concurrently present the status of the update.

20. The computer program product of claim 17, wherein the program code is further configured to cause the electronic device to provide functionality of:
determining that the likelihood of usage is less than the likelihood threshold in response to determining that the second electronic device is in use by a user, and that the first companion device is not in use.
